(19) United States
(12) Patent Application Publication
(10) Pub. No.: US 2009/0137391 A1
(43) Pub. Date: May 28, 2009

(54) Use of benzyladenine to improve emergence of seeds treated with abscisic acid

(76) Inventors: Dale O. Wilson, JR., Round Lake Beach, IL (US); Nicole Higgs, Racine, WI (US); Mariola Kopcinski, Hawthorne Woods, IL (US); Peter D. Petracek, Grayslake, IL (US); Prem Warrior, Green Oaks, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/214,679

(22) Filed: Jun. 20, 2008

Related U.S. Application Data
(60) Provisional application No. 60/936,499, filed on Jun. 20, 2007.

(51) Int. Cl. A01N 43/90

(52) U.S. Cl. 504/136; 504/241

(57) ABSTRACT

This invention relates to the use of N⁶-phenylmethyl-1H-purin-6-amine (benzyladenine) in combination with S—(+)-abscisic acid (ABA), ABA analogs or derivatives to improve the performance of germination delay seed treatments.

### FIELD OF THE INVENTION

The present invention is directed to improving the performance of S-(+)- abscisic acid (ABA; S-ABA), ABA analogs or ABA derivatives as emergence delay agents for field planting by treatment of seed with N⁶-phenylmethyl-1H-purin-6-amine (benzyladenine; BA; 6BA; N⁶-benzyladenine), either as a mixture with the ABA or as a separate application.

### BACKGROUND OF THE INVENTION

ABA is a natural plant growth regulator that is responsible for dormancy of many kinds of seeds and buds (Finch-Savage and Leubner-Metzger, 2006). Benzyladenine is a powerful cytokinin. Cytokinins promote cell proliferation and shoot differentiation in plants (Schmülling, 2004. Cytokinin. In Encyclopedia of Biological Chemistry (Eds. Lennarz, W., Lane, M.D.) Academic Press/Elsevier Science).

ABA can be used to delay germination and soil emergence of canola. However, one of the problems associated with this use of ABA on canola is that high doses (>500 ppm, seed weight basis) may result in a very long, practically permanent dormancy in a sub-population of the seeds. Accordingly, there is a need for formulations that would prevent permanent dormancy of ABA-treated seeds.

While gibberellins are known to counteract the inhibitory effects of ABA on seed germination (Kucera, et al., Plant hormone interactions during seed dormancy release and germination. Seed Science Research (2005) 15, 281-307), cytokinins are not known to counteract the effects of ABA on seeds.

Surprisingly, co-treatment of ABA-treated seeds with benzyladenine is able to rescue these seeds, resulting in much higher, agronomically acceptable emergence. The co-treatment retains the emergence delay produced by the high dose of ABA, making possible both long germination delay (about 7 days at 10° C.), and high ultimate emergence (>80%).

### SUMMARY OF THE INVENTION

In one embodiment, the present invention is generally directed to a method of seed treatment with N⁶-benzyladenine and S-(+)- abscisic acid or analogs or derivatives of ABA. This combination produces an agronomically acceptable final stand, while still permitting substantial emergence delay. This delay could be used to avoid killing frost due to early planting (late autumn or early spring) and thus extending the planting. This delay could also be used to delay the emergence of male inbreds and thus extend the pollination window of hybrid seed production.

### DETAILED DESCRIPTION OF THE INVENTION

S-(+)- abscisic acid (ABA; S-ABA; CAS no. 21293-29-8) is a naturally occurring plant hormone which acts primarily to inhibit growth, maintain dormancy of buds, promote fruit maturation or coloration, activate the pathogen resistance response defense, induce senescence in already-damaged cells and their proximate neighbors, and help the plant tolerate stressful conditions. See Arteca, R. (1996), Plant Growth Substances: Principles and Applications. New York: Chapman & Hall; Mauseth, J. D. (1991), Botany: An Introduction to Plant Biology. Philadelphia: Saunders. pp. 348-415; Raven, P. H., Evert, R. F., and Eichhorn, S. E. (1992), Biology of Plants. New York: Worth. pp. 545-572.

The natural compound has been indicated as (S) or (+), its synthetic or racemic substance as (RS) or (+/−), and its enantiomer as (−). ABA in its natural form (+), its synthetic or racemic forms, enantiomers, mixtures of forms, and derivatives may all be used according to the present invention.

Presently preferred ABA analogs include PBI-429, PBI-702, and PBI-488.

For the purposes of this Application, abscisic acid analogs are represented by Structures 1, 2, and 3, wherein for Structure 1:
the bond at the 2-position of the side chain is a cis- or trans-double bond,
the bond at the 4-position of the side chain is a trans-double bond or a triple bond,
the stereochemistry of the alcoholic hydroxyl group is S-, R- or an R,S-mixture,
the stereochemistry of the R₁ group is in a cis-relationship to the alcoholic hydroxyl group,
R₁ is ethynyl, ethenyl, cyclopropyl or trifluoromethyl, and
R₂ is hydrogen or lower alkyl;

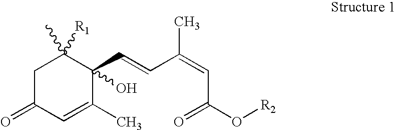

wherein lower alkyl is defined as containing 1 to 4 carbon atoms in a straight or branched chain, which may comprise one ring or contain at least one double bond when 3 or more carbon atoms are present.

A presently preferred compound of structure 1 is PBI-429 where R₁ is ethynyl and R₂ is a methyl group.

For Structure 2:
the bond at the 4-position of the side chain is a triple bond,
the bond at the 2-position of the side chain is a trans-double bond or a cis-double bond,
the stereochemistry of the alcoholic hydroxyl group is S-, R- or an R,S- mixture, and R₁ is hydrogen or lower alkyl;

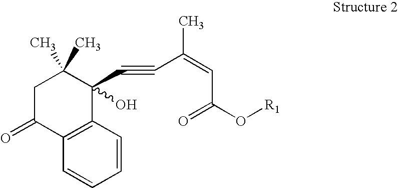

wherein lower alkyl is defined as containing 1 to 4 carbon atoms in a straight or branched chain, which may comprise one ring or contain at least one double bond when 3 or more carbon atoms are present.

A presently preferred compound of structure 2 is PBI-702 where R₁ is a methyl group.

For Structure 3:
the bond at the 2-position of the side chain is a cis- or trans- double bond,
the bond at the 4-position of the side chain is a trans- double bond or a triple bond,
the stereochemistry of the alcoholic hydroxyl group is S-, R- or an R,S- mixture, and R₁ is hydrogen or lower alkyl;

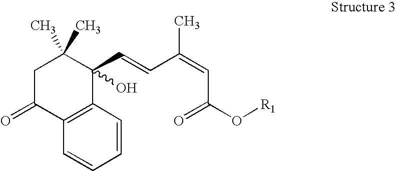

wherein lower alkyl is defined as containing 1 to 4 carbon atoms in a straight or branched chain, which may comprise one ring or contain at least one double bond when 3 or more carbon atoms are present.

A presently preferred compound of structure 3 is PBI-488 where R₁ is a methyl group. It is also contemplated that salts of the ABA and the ABA analogs may be utilized in accordance with the present invention.

Cytokinins are naturally occurring plant hormones that are required for cell division in apical meristems, regulation of sink strength and leaf development in the shoot. Benzyladenine is one of the most common cytokinins in commercial use.

In one embodiment, the present invention is directed to a method of improving emergence of seeds comprising applying an effective amount of N⁶-benzyladenine to seeds that have been treated with ABA, ABA analogs or ABA derivatives.

In another embodiment, the present invention is directed to a method of improving emergence of seeds comprising simultaneously applying to said seeds an effective amount of N⁶-benzyladenine and an effective amount of ABA, ABA analogs or ABA derivatives.

In another embodiment, the present invention is directed to a method of increasing the maximum tolerable amount of ABA, ABA analogs or ABA derivatives that can be used for seed treatment by treating the seeds with N⁶-benzyladenine either concurrently with or following said treatment.

Depending on species, an effective amount of N⁶-benzyladenine and an effective amount of ABA, ABA analogs and ABA derivatives applied to seeds can vary within wide ranges.

In one embodiment, an effective amount of N⁶-benzyladenine is from about 0.01 g/cwt to about 25 g/cwt on a seed weight basis, where 1 cwt is defined as 100 pounds of seed. In a preferred embodiment, an effective amount of N⁶-benzyladenine is from about 1 g/cwt to about 25 g/cwt.

In one embodiment, an effective amount of ABA, ABA analogs, and ABA derivatives is from about 1 g/cwt to about 500 g/cwt. In a preferred embodiment, an effective amount of ABA, ABA analogs and ABA derivatives is from about 25 g/cwt to about 100 g/cwt.

Techniques of seed treatment application are well known to those skilled in the art, and they may be readily used in the context of the present invention. The compositions of the present invention may be applied as a slurry or soak. Film coating and encapsulation may also be used. The coating processes are well known in the art and employ the techniques of film coating, encapsulation, immersion, etc. The methods of application of the compositions of the present invention may be varied, and the invention is intended to include any technique that is to be used by one of skill in the art.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

Throughout the application, the singular forms “a,” “an,” and “the” include plural reference unless the context clearly dictates otherwise.

The following examples are intended to illustrate the present invention and to teach one of ordinary skill in the art how to make and use the invention. They are not intended to be limiting in any way.

### EXAMPLES

### Example 1

### Effect of Benzyladenine Technical Powder on ABA Induced Germination Delay in Canola

### Method

The experiment was set up as an ABA-dose×BA-dose factorial experiment, with four doses of ABA (0, 25, 50, and 100 g/cwt) and four doses of benzyladenine (0, 1, 5 and 25 g/cwt) for a total of 16 treatment combinations. The treatments were made up in 1 ml samples of experimental aqueous seed treatment slurry. ABA was added in the form of a water solution of the ammonium salt. Benzyladenine was added as technical powder. Ten μl Tween-20 were added to each sample to help wet and suspend the benzyladenine powder. All of the seed treatment slurry samples contained CF-Clear film-forming agent and Color Coat Red (Becker Underwood), each at 1 oz/cwt, and 0.167 oz/cwt Maxim XL fungicide (Syngenta). The slurry application volume was 40 oz/cwt (cwt=100 lbs of seed). Ten gram samples of canola seed were treated with the experimental slurries using a Hege 11 seed treater with a six-inch bowl.

The seed was planted in plastic boxes containing 1 kg of typical agricultural silt loam. One hundred seeds were planted 2 cm deep in each plastic box, and the soil in the box was adjusted to 21% soil moisture (wet-weight basis). Two replications of the experiment were incubated under constant light in a 10° C. chamber. The soil temperature averaged 12.6° C. The boxes were watered up to the correct weight every 1-2 days, and checked for emergence. Counts of seedlings were continued until it became clear that emergence had ceased (28 days). The final count of emerged seedlings was expressed as a percentage of the 100 seeds planted.

The daily counts were converted to proportions of the final emergence of the box, and a Gompertz curve was fitted to the data from each box using SAS Proc NLIN. From the parameters of the model, median emergence time (T50) and quartile range (Qrange) were estimated for each box. Analysis of variance was performed and means calculated for each of the three responses (Final emergence, T50, Qrange).

### Results

TABLE 1
Effect of including benzyladenine technical powder in ABA-based
seed treatments to delay emergence of canola.

| ABA dose | Benzyladenine | Final | | |
|---|---|---|---|---|
| (g/cwt) | dose (g/cwt) | emergence (%) | T50 (days) | Qrange (days) |
| 0 | 0 | 99.0 | 6.34 | 1.88 |
| 0 | 1 | 98.0 | 6.37 | 1.30 |
| 0 | 5 | 91.6 | 6.76 | 2.36 |
| 0 | 25 | 89.9 | 7.88 | 3.02 |
| 25 | 0 | 92.3 | 9.15 | 3.26 |
| 25 | 1 | 89.8 | 9.07 | 3.06 |
| 25 | 5 | 94.5 | 8.99 | 3.18 |
| 25 | 25 | 91.1 | 9.64 | 3.80 |
| 50 | 0 | 68.9 | 11.20 | 4.27 |
| 50 | 1 | 88.9 | 10.07 | 4.00 |
| 50 | 5 | 90.2 | 10.73 | 4.27 |
| 50 | 25 | 91.7 | 11.52 | 4.72 |
| 100 | 0 | 53.5 | 12.74 | 4.27 |
| 100 | 1 | 85.4 | 13.20 | 5.23 |
| 100 | 5 | 96.0 | 11.73 | 4.34 |
| 100 | 25 | 84.0 | 12.99 | 4.99 |

As the dose of ABA was increased from zero to 100 g/cwt, the final emergence declined, and was roughly cut in half at a dose of 100 g/cwt. Surprisingly, addition of benzyladenine prevented loss of final emergence that resulted from high doses of ABA.. No significant effect on median-time-to-emergence occurred from benzyladenine addition.

### Example 2

### Effect of Benzyladenine as Maxcel® on ABA Induced Germination Delay in Canola

### Background

Maxcel is a liquid formulation of benzyladenine commonly applied to fruit crops. This experiment evaluated the effect of this form of benzyladenine on the response to benzyladenine of ABA-induced dormancy in canola seed.

### Method

The experiment was set up as an ABA-dose x benzyladenine-dose factorial experiment, with four doses of ABA (0, 25, 50 and- 100 g/cwt) and three doses of benzyladenine (0, 1 and 5 g/cwt) for a total of 12 treatment combinations. The treatments were made up in 1 ml samples of experimental aqueous seed treatment slurry. ABA was added in the form of a water solution of the ammonium salt. Benzyladenine was added in the form of Maxcel. Treatments receiving less than the maximum amount of Maxcel, received an appropriate amount of Maxcel blank formulation, so that each slurry sample was identical with regard to Maxcel inert ingredients. All of the seed treatment slurry samples contained CF-Clear film-forming agent and Colorcoat Red (Becker Underwood), each at 1 oz/cwt, and 0.167 oz/cwt Maxim XL fungicide (Syngenta). The slurry application volume was 40 oz/cwt (cwt=100 lbs of seed). Ten gram samples of canola seed were treated with the experimental slurries using a Hege 11 seed treater with a six-inch bowl.

The seed was germinated and data analyzed as described under Example 1.

### Results

TABLE 2
Effect of including benzyladenine in the form of Maxcel ® in
ABA-based seed treatments to delay emergence of canola.

| ABA dose | Benzyladenine | Final | | |
|---|---|---|---|---|
| (g/cwt) | dose (g/cwt) | emergence (%) | T50 (days) | Qrange (days) |
| 0 | 0 | 98.1 | 5.66 | 1.13 |
| 0 | 1 | 97.5 | 6.02 | 1.84 |
| 0 | 5 | 97.1 | 6.09 | 1.77 |
| 25 | 0 | 92.9 | 8.17 | 2.06 |
| 25 | 1 | 92.3 | 8.77 | 2.76 |
| 25 | 5 | 91.1 | 8.50 | 2.34 |
| 50 | 0 | 91.4 | 10.57 | 3.74 |
| 50 | 1 | 92.5 | 10.06 | 3.68 |
| 50 | 5 | 92.0 | 10.44 | 4.09 |
| 100 | 0 | 49.5 | 13.61 | 5.84 |
| 100 | 1 | 80.7 | 12.42 | 4.68 |
| 100 | 5 | 80.3 | 13.90 | 5.47 |

As the dose of ABA was increased to 100 g/cwt, the final emergence declined, and was roughly cut in half at a dose of 100 g/cwt. Again, addition of benzyladenine prevented loss of final emergence that resulted from high doses of ABA, and no significant effect on median-time-to-emergence occurred from benzyladenine addition.

### Example 3

### Effect of CPPU on ABA Induced Germination Delay in Canola

### Background

CPPU is a powerful, synthetic cytokinin active at very low doses. CPPU was evaluated as a way to improve final emergence of ABA-treated canola seed.

### Methods

The experiment was set up as an ABA-dose×CPPU-dose factorial experiment, with four doses of ABA (0, 25, 50 and 100 g/cwt) and three doses of CPPU (0, 0.04, 0.2 and 1 g/cwt) for a total of 16 treatment combinations. The treatments were made up in 1 ml samples of experimental aqueous seed treatment slurry. ABA was added as the free acid. CPPU was added in the form of Prestige®. Treatments receiving less than the maximum amount of Prestige, received an appropriate amount of Prestige blank formulation, so that each slurry sample was identical with regard to Prestige inert ingredients. All of the seed treatment slurry samples contained CF-Clear film-forming agent and Colorcoat Red (Becker Underwood), each at 1 oz/cwt, and 0.167 oz/cwt Maxim XL fungicide (Syngenta). The slurry application volume was 40 oz/cwt (cwt=100 lbs of seed). Ten gram samples of canola seed were treated with the experimental slurries using a Hege 11 seed treater with a six-inch bowl.

The seed was germinated and data analyzed as described under Example 1, except that emergence, being unusually low in this trial, rendered the quartile range estimates unreliable. Therefore, quartile range values are not shown.

### Results

TABLE 3
Effect of adding CPPU in the form of Prestige to ABA-based
seed treatments to delay emergence of canola.

| ABA dose | CPPU dose | Final | |
|---|---|---|---|
| (g/cwt) | (g/cwt) | emergence (%) | T50 (days) |
| 0 | 0 | 76.8 | 7.50 |
| 0 | 0.04 | 80.3 | 7.12 |
| 0 | 0.2 | 78.1 | 7.48 |
| 0 | 1 | 77.6 | 8.30 |
| 25 | 0 | 84.0 | 10.4 |
| 25 | 0.04 | 47.0 | 13.02 |
| 25 | 0.2 | 38.9 | 12.50 |
| 25 | 1 | 39.4 | 14.24 |
| 50 | 0 | 66.0 | 12.16 |
| 50 | 0.04 | 27.4 | 20.28 |
| 50 | 0.2 | 18.5 | 17.96 |
| 50 | 1 | 31.8 | 12.81 |
| 100 | 0 | 48.0 | 16.48 |
| 100 | 0.04 | 18.0 | 18.92 |
| 100 | 0.2 | 16.4 | 20.38 |
| 100 | 1 | 18.0 | 20.42 |

As in Examples 1 and 2, treatment of the seed with high doses of ABA resulted in significant and important reduction in emergence. Unlike benzyladenine, treatment with a different cytokinin, CPPU, failed to improve emergence of these seeds rendered dormant by application of ABA.

### Example 4

### Effect of GA4/7 on ABA Induced Germination Delay in Canola

### Background

The interaction between endogenous abscisic acid (ABA) and gibberellins in the regulation of dormancy and germination is well known. Co-applying gibberellins with ABA to obtain higher final emergence was a natural thing to evaluate.

### Methods

The experiment was set up as an ABA-dose×GA4/7-dose factorial experiment, with four doses of ABA (0, 25, 50 and 100 g/cwt) and three doses of GA4/7 (0, 1, 5 and 25 g/cwt) for a total of 16 treatment combinations. The treatments were made up in 1 ml samples of experimental aqueous seed treatment slurry. ABA and GA4/7 were added as the free acid technical powders. All of the seed treatment slurry samples contained CF-Clear film-forming agent and Colorcoat Red (Becker Underwood), each at 1 oz/cwt, and 0.167 oz/cwt Maxim XL fungicide (Syngenta). The slurry application volume was 40 oz/cwt (cwt=100 lbs of seed). Ten gram samples of canola seed were treated with the experimental slurries using a Hege 11 seed treater with a six-inch bowl.

### Results

TABLE 4
Effect of adding GA4/7 to ABA-based seed
treatments to delay emergence of canola.

| ABA dose | GA4/7 dose | Final | | |
|---|---|---|---|---|
| (g/cwt) | (g/cwt) | emergence (%) | T50 (days) | QR (days) |
| 0 | 0 | 86.14 | 6.73 | 1.37 |
| 0 | 1 | 82.52 | 6.36 | 0.95 |
| 0 | 5 | 86.69 | 7.03 | 2.11 |
| 0 | 25 | 85.55 | 6.74 | 1.35 |
| 25 | 0 | 84.0 | 10.42 | 3.33 |
| 25 | 1 | 81.01 | 9.45 | 2.82 |
| 25 | 5 | 86.66 | 9.07 | 2.68 |
| 25 | 25 | 84.77 | 9.57 | 2.95 |
| 50 | 0 | 66.0 | 12.16 | 3.38 |
| 50 | 1 | 86.14 | 11.00 | 3.93 |
| 50 | 5 | 84.91 | 9.96 | 2.56 |
| 50 | 25 | 84.04 | 9.76 | 2.72 |
| 100 | 0 | 48.0 | 16.48 | 5.69 |
| 100 | 1 | 82.52 | 12.61 | 5.40 |
| 100 | 5 | 80.80 | 13.25 | 6.47 |
| 100 | 25 | 85.01 | 11.91 | 4.64 |

As in Examples 1-3, treatment of seed with high doses of ABA alone resulted in significant and important reduction in emergence. Addition of GA4/7 significantly increased emergence. However, the GA4/7 also produced a significant reduction in the delay produced by the ABA treatment. Since the main purpose of these treatments is to produce emergence delay, addition of GA4/7 is counterproductive. The GA4/7 also produced excessive seedling elongation (data not shown).

1. A method of increasing a non-phytotoxic amount of S-(+)-abscisic acid or an agriculturally acceptable analog or derivative thereof that can be applied to seeds comprising applying to said seeds an effective amount of benzyladenine.

2. The method of claim 1, wherein benzyladenine is applied concurrently with S-(+)-abscisic acid or an agriculturally acceptable analog or derivative thereof.

3. The method of claim 1, wherein benzyladenine is applied after applying to said seeds S-(+)-abscisic acid or an agriculturally acceptable analog or derivative thereof.

4. A method of claim 1, wherein the effective amount of benzyladenine is from about 0.01 g/cwt to about 25 g/cwt on a seed weight basis.

5. A method of increasing soil emergence of seeds that have been treated with S-(+)-abscisic acid or an agriculturally acceptable analog or derivative thereof comprising applying to said seeds an effective amount of benzyladenine.

6. The method of claim 5, wherein benzyladenine is applied concurrently with S-(+)-abscisic acid or an agriculturally acceptable analog or derivative thereof.

7. The method of claim 5, wherein benzyladenine is applied after applying to said seeds S-(+)-abscisic acid or an agriculturally acceptable analog or derivative thereof.

8. The method of claim 1, wherein said effective amount is a ratio of S-(+)-abscisic acid: benzyladenine in the range of 100:1 to 4:1.

9. A composition for the treatment of seeds that comprises an effective amount of S-(+)-abscisic acid or an agriculturally acceptable analog or derivative thereof and benzyladenine.
